(19) United States
(12) Patent Application Publication
(10) Pub. No.: US 2021/0270403 A1
(43) Pub. Date: Sep. 2, 2021

(54) END CAP

(71) Applicants: Sandy Wayne WILLIAMS, Kinuso (CA); Darwin Ernest DELEEUW, Athabasca (CA)

(72) Inventors: Sandy Wayne WILLIAMS, Kinuso (CA); Darwin Ernest DELEEUW, Athabasca (CA)

(21) Appl. No.: 16/804,439

(22) Filed: Feb. 28, 2020

(51) Int. Cl. F16L 55/115

(52) U.S. Cl. CPC F16L 55/1152; F16L 55/1157

(57) ABSTRACT

An end cap for sealing an end of an existing pipe comprising a cylindrical cap member, the cylindrical cap member comprising an open end and a closed end, a clamp coupled to a band, a band track present along an exterior of the cylindrical cap member, the band encompassing the band track and one or more ribs present on an interior of the cylindrical cap member opposite to the band track. A method of using the end cap to seal an end of an existing pipe, comprising unlocking the clamp, inserting the end cap over the end of the existing pipe and locking the clamp.

### FIELD OF THE INVENTION

The present disclosure relates to an end cap, more specifically but not by way of limitation, an end cap that is effortlessly installed to a pipe or conduit for effectively sealing.

### BACKGROUND

The ability to confidently seal pipes and conduits is crucial across a multitude of applications in order to avoid damage, loss of precious materials and safety concerns. Current methods for sealing pipe and conduits typically comprise end cap devices which either provide adequate sealing but involve extensive installation time and effort or provide swift installation without a confident seal.

U.S. Pat. No. 3,713,463 A (Bywater, Jr.) discloses a cylindrical closure member for pipes and conduits which is accompanied with a surrounding clamp. Shortcomings include the extensive effort required to secure on an existing pipe as well as a lack of features to ensure proper seal is maintained and the device remain fixed to the existing pipe.

U.S. Pat. No. 5,758,693 A (Caine) discloses an end cap for recreational vehicles which is accompanied with a surrounding clamp. Shortcomings include the extensive effort required to secure on an existing pipe as well as a lack of features to ensure proper seal is maintained and the device remain fixed to the existing pipe.

U.S. Pat. No. 6,568,430 B1 (Shafer) discloses a pipe end cap which utilizes a quick release latching mechanism. Shortcomings include a lack adjustment capability when installing on existing pipe as well as a lack of features to ensure proper seal is maintained and the device remain fixed to the existing pipe.

U.S. Pat. No. 2010/0037977 A1 (Rahimzadeh et al.) discloses a pipe cap with an additional member to regulate water flow within the pipe. Shortcomings include the bulkiness of the device as well as the extensive effort required to install and secure on an existing pipe.

All documents cited herein are incorporated by reference.

There is a need for a device that securely seals an open end of an existing pipe or conduit that can be employed in a timely, effortless manner.

### BRIEF SUMMARY

It is the object of the present invention to provide an end cap.

In accordance with an aspect of the invention, there is provided an end cap for sealing an end of an existing pipe comprising a cylindrical cap member, the cylindrical cap member comprising an open end and a closed end, a clamp coupled to a band, a band track present along an exterior of the cylindrical cap member, the band encompassing the band track and one or more ribs present on an interior of the cylindrical cap member opposite to the band track.

In accordance with another aspect of the invention, there is provided a method of using the end cap to seal an end of an existing pipe, comprising unlocking the clamp, inserting the end cap over the end of the existing pipe and locking the clamp.

In accordance with an embodiment of the invention, one or more band screws may be inserted through the band and the cylindrical cap member.

In accordance with an embodiment of the invention, the band comprises one or more band holes which may be inserted through the band holes and the cylindrical cap member.

In accordance with an embodiment of the invention, the cylindrical cap member is composed of an elastomeric material.

In accordance with an embodiment of the invention, the clamp employs a ratcheting mechanism for locking, unlocking and tightening the clamp and the band.

In accordance with an embodiment of the invention, the clamp employs a latching mechanism for locking the clamp and the band.

In accordance with an embodiment of the invention, a locking pin is inserted through the clamp once the clamp is locked.

In accordance with an embodiment of the invention, the clamp employs a spring-loaded mechanism for locking the clamp and the band.

In accordance with an embodiment of the invention, the clamp employs a combination of a ratcheting, latching or spring-loaded mechanism for locking the clamp and the band.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a horizontal view of an end cap with a clamp and a band 100 in accordance with one embodiment.

FIG. 2 illustrates a horizontal view of an end cap without a clamp and a band 200 in accordance with one embodiment.

FIG. 3 illustrates an isolated view of a clamp and band 300 in accordance with one embodiment.

FIG. 4 illustrates a vertical view of an end cap with clamp 400 in accordance with one embodiment.

FIG. 5 illustrates a cross section of a cylindrical cap member 500 in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

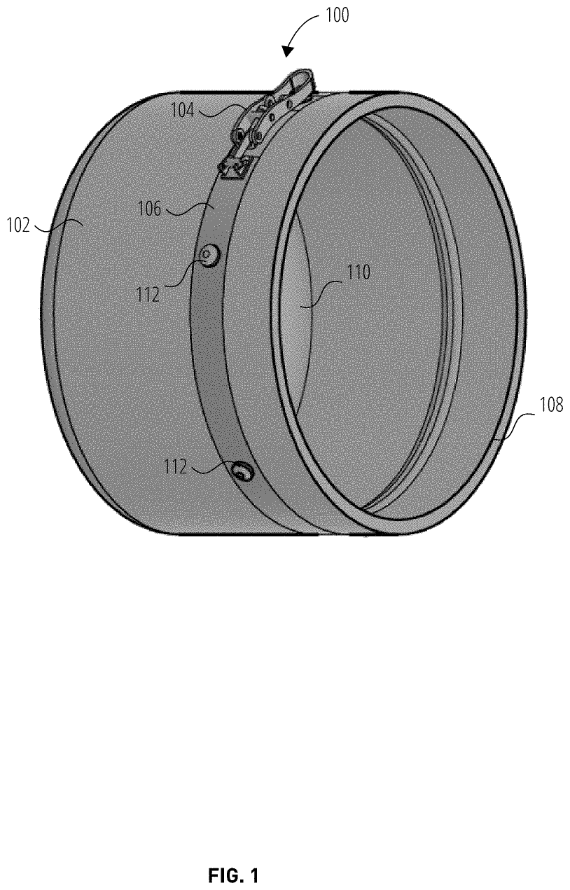

FIG. 1 depicts a horizontal view of an end cap with a clamp and a band 100 as in one embodiment. The cylindrical cap member 102 is shown with a clamp 104 coupled to a band 106 encompassing the exterior of the cylindrical cap member 102. The cylindrical cap member 102 is cylindrically shaped and comprises an open end 108 and a closed end 110 where the open end 108 is employed to encapsulate an open end of an existing pipe or a conduit. The clamp employed for securing the end cap may encompass a wide range of fasteners in the art and is not limited to the examples shown in the displayed figures.

While installing the end cap, the clamp 104 must be in an unlocked state to allow for the end cap to be inserted over the end of the existing pipe or conduit. While employed with the clamp 104 in a locked position, the cylindrical cap member 102 functions to securely seal an open end of an existing pipe or conduit in a timely, effortless manner. In additional embodiments, the cylindrical cap member 102 may be further secured to an existing pipe or conduit through inserting one or more band screws through the band 106 and the cylindrical cap member 102. In additional embodiments, the cylindrical cap member 102 is composed of an elastomeric material.

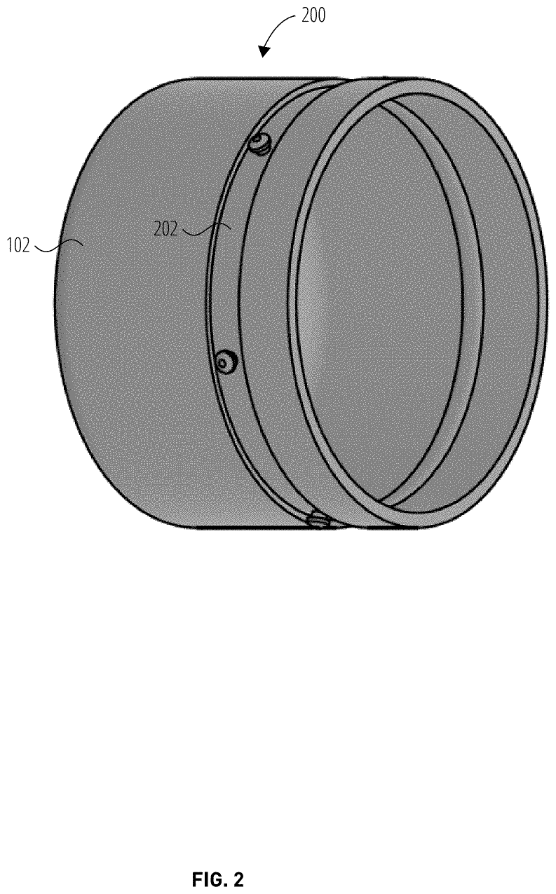

FIG. 2 depicts a horizontal view of an end cap without a clamp and a band 200 as in one embodiment. The cylindrical cap member 102 is shown with a band track 202 present along the exterior of the cylindrical cap member 102 in place of the clamp 104 and band 106 from FIG. 1. The band track 202 allows timely and effortless installation of the clamp 104 and band 106 onto the cylindrical cap member 102 as well as provides further constraint for the clamp 104 and band 106 to remain in place.

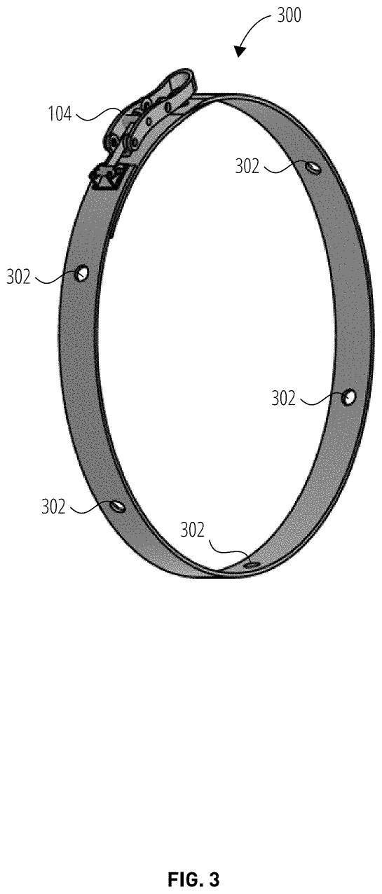

FIG. 3 depicts an isolated view of a clamp and band 300 as in one embodiment. The clamp 104 is shown coupled to the band 106 which is accompanied with a plurality of band holes. In this example, the clamp 104 shown is in a locked position where the clamp 104 employs a latching mechanism for locking and unlocking the clamp 104 and band 106. In additional embodiments, the band 106 comprises one or more band holes. In additional embodiments, the cylindrical cap member 102 may be further secured to an existing pipe or conduit through inserting one or more band screws through one or more band holes and the cylindrical cap member 102. In another embodiment, the clamp employs a spring-loaded mechanism for locking the clamp and the band. In another embodiment, the clamp employs a combination of a ratcheting, latching or spring-loaded mechanism for locking the clamp and the band.

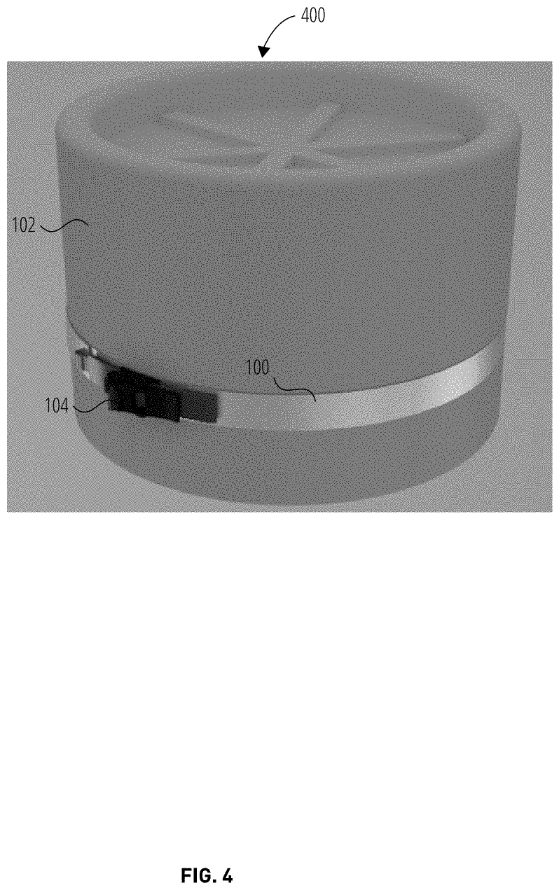

FIG. 4 depicts a vertical view of an end cap with clamp 400 as in one embodiment. The clamp 104 is shown coupled to the band 106 encompassing the exterior of the cylindrical cap member 102. In this example, the clamp 104 shown is in a locked position which employs a ratcheting mechanism for locking, unlocking and tightening the clamp 104 and band 106. In additional embodiments, a locking pin is inserted into the clamp 104 further securing the clamp 104 in a locked position and the end cap to the existing pipe or conduit.

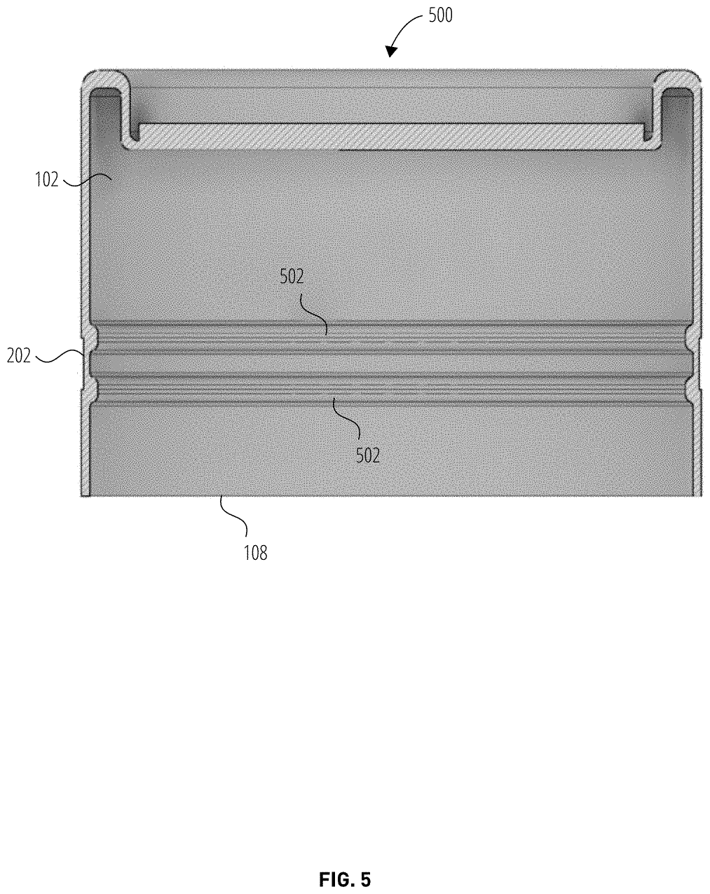

FIG. 5 depicts a cross section of a cylindrical cap member 500 of the end cap as in one embodiment. In this example, a cross section of the cylindrical cap member 102 is shown with two ribs present on the interior of the cylindrical cap member 102 and a band track 202 present along the exterior of the cylindrical cap member 102. While tightening the clamp 104 or locking the clamp 104, the band 106 encompassing the band track 202 applies a centripetal force allowing one or more ribs to securely grip the end of the open end of an existing pipe or a conduit. In additional embodiments, one or more ribs may be present on an interior of the cylindrical cap member 102 opposite to the band track 202 which allow for increased rigidity and improved sealing capability.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

What is claimed is:

1. An end cap for sealing an end of an existing pipe comprising:
a cylindrical cap member;
said cylindrical cap member comprising an open end and a closed end;
a clamp coupled to a band;
a band track present along an exterior of said cylindrical cap member,
said band encompassing said band track; and
one or more ribs present on an interior of said cylindrical cap member opposite to said band track.

2. The end cap of claim 1 wherein one or more band screws may be inserted through said band and said cylindrical cap member.

3. The end cap of claim 1 wherein said band comprises one or more band holes.

4. The end cap of claim 1 wherein said cylindrical cap member is composed of an elastomeric material.

5. The end cap of claim 3 wherein one or more band screws may be inserted through said band holes and said cylindrical cap member.

6. The end cap of claim 1 wherein said clamp employs a ratcheting mechanism for locking, unlocking and tightening said clamp and said band.

7. The end cap of claim 1 wherein said clamp employs a latching mechanism for locking said clamp and said band.

8. The end cap of claim 1 wherein said clamp employs a spring-loaded mechanism for locking said clamp and said band.

9. The end cap of claim 1 wherein said clamp employs a combination of a ratcheting, latching or spring-loaded mechanism for locking said clamp and said band.

10. A method of using the end cap of claim 1, to seal an end of an existing pipe, comprising:
unlocking said clamp;
inserting said end cap over said end of said existing pipe; and
locking said clamp.

11. A method of using the end cap of claim 1, wherein a locking pin is inserted through said clamp once said clamp is locked.
